(19) United States
(12) Patent Application Publication
(10) Pub. No.: US 2023/0395802 A1
(43) Pub. Date: Dec. 7, 2023

(54) ALL SOLID STATE BATTERY AND METHOD FOR PRODUCING THE SAME

(71) Applicants: Kei Oura, Toyota-shi, Aichi-ken (JP); Robin von Hagen, Wesel (DE); Akihiro Wakahara, Shinjuku-ku, Tokyo-to (JP); Megumu Takai, Shinjuku-ku, Tokyo-to (JP)

(72) Inventors: Kei Oura, Toyota-shi, Aichi-ken (JP); Robin von Hagen, Wesel (DE); Akihiro Wakahara, Shinjuku-ku, Tokyo-to (JP); Megumu Takai, Shinjuku-ku, Tokyo-to (JP)

(73) Assignees: TOYOTA JIDOSHA KABUSHIKI KAISHA, Toyota-shi, Aichi-ken (JP); BYK-CHEMIE GMBH, Wesel (DE)

(21) Appl. No.: 18/249,875

(22) PCT Filed: Oct. 23, 2020
(86) PCT No.: PCT/JP2020/039899

§ 371 Date: Apr. 20, 2023

(51) Int. Cl. H01M 4/62; H01M 10/0585; H01M 10/0562

(52) U.S. Cl. CPC H01M 4/62; H01M 10/0585; H01M 10/0562; H01M 2004/028

(57) ABSTRACT

A main object of the present disclosure is to provide an all solid state battery including a dispersant-containing layer with good solid electrolyte dispersibility. The present disclosure solves the above problem by providing an all solid state battery comprising a cathode layer, an anode layer, and a solid electrolyte layer disposed between the cathode layer and the anode layer, and at least one of the cathode layer, the anode layer, and the solid electrolyte layer is a dispersant-containing layer including at least a solid electrolyte and a dispersant, an amine value of the dispersant is 20 mgKOH/g or more and 200 mgKOH/g or less, a weight-average molecular weight of the dispersant is less than 1,500,000 g/mol, and a proportion of the dispersant in the dispersant-containing layer is 0.1 weight % or more and 20 weight % or less.

### TECHNICAL FIELD

The present disclosure relates to an all solid state battery and a method for producing the same.

### BACKGROUND ART

An all solid state battery is a battery including a solid electrolyte layer between a cathode layer and an anode layer, and having an advantage that, compared to a liquid based battery having a liquid electrolyte including a flammable organic solvent, it is easier to simplify the safeguard thereof. A carbon material is used as a conductive material for a cathode layer and an anode layer in the all solid state battery in some cases, and a dispersant for improving the dispersibility of the carbon material is known. For example, Patent Literature 1 discloses a dispersant for a carbon material including a copolymer containing a nitrogen atom.

Also, although it is not an all solid state battery technology, Patent Literature 2 discloses a dispersant including a carboxylic acid and an amine. Patent Literature 2 further discloses removal of a deposited material formed within an engine, by using the dispersant. Also, although it is not an all solid state battery technology as Patent Literature 2, Patent Literature 3 discloses a binder composition for a lithium ion secondary battery electrode including a water-soluble polymer X (with degree of liquid electrolyte swelling of 120 mass % of less), an amphoteric dispersant Y, and a solvent.

### CITATION LIST

### Patent Literature

PTL 1: Japanese Patent Application Laid-Open (JP-A) No. 2019-046796
PTL 2: JP-A No. 2014-065848
PTL 3: JP-A No. 2016-149313

### SUMMARY OF INVENTION

### Technical Problem

In a liquid based battery, an ion is conducted via a liquid electrolyte having flowability. In contrast, in an all solid state battery, the ion is conducted via a solid electrolyte having no flowability. In order to form a good ion conductive path, the dispersibility of the solid electrolyte (evenness and stability in relation to dispersing) is preferably improved.

The present disclosure has been made in view of the above circumstances, and a main object thereof is to provide an all solid state battery including a dispersant-containing layer with good solid electrolyte dispersibility.

### Solution to Problem

In order to achieve the object, the present disclosure provides an all solid state battery comprising a cathode layer, an anode layer, and a solid electrolyte layer disposed between the cathode layer and the anode layer, and at least one of the cathode layer, the anode layer, and the solid electrolyte layer is a dispersant-containing layer including at least a solid electrolyte and a dispersant, an amine value of the dispersant is 20 mgKOH/g or more and 200 mgKOH/g or less, a weight-average molecular weight of the dispersant is less than 1,500,000 g/mol, and a proportion of the dispersant in the dispersant-containing layer is 0.1 weight % or more and 20 weight % or less.

According to the present disclosure, by using a specific dispersant in a predetermined proportion, an all solid state battery including a dispersant-containing layer with good solid electrolyte dispersibility may be obtained.

In the disclosure, the weight-average molecular weight of the dispersant may be 300 g/mol or more and 150,000 g/mol or less.

In the disclosure, an acid value of the dispersant may be 0 mgKOH/g or more and 50 mgKOH/g or less.

In the disclosure, the dispersant-containing layer may include an aminoamide as the dispersant.

In the disclosure, the aminoamide may include at least one of an unsaturated polyaminoamide and alkylolaminoamide.

In the disclosure, the dispersant-containing layer may include a polyester-polyamine copolymer as the dispersant.

In the disclosure, the cathode layer may be the dispersant-containing layer, and a proportion of the solid electrolyte in the cathode layer may be 10 weight % or more and 30 weight % or less.

In the disclosure, the anode layer may be the dispersant-containing layer, and a proportion of the solid electrolyte in the anode layer may be 10 weight % or more and 30 weight % or less.

In the disclosure, the solid electrolyte layer may be the dispersant-containing layer, and a proportion of the solid electrolyte in the solid electrolyte layer may be 60 weight % or more.

The present disclosure also provides a method for producing the above described all solid state battery, and the dispersant-containing layer is formed by using a slurry including at least the solid electrolyte and the dispersant.

According to the present disclosure, by using a slurry including a specific dispersant, an all solid state battery including a dispersant-containing layer with good solid electrolyte dispersibility may be obtained.

### Advantageous Effects of Invention

The present disclosure exhibits an effect that the all solid state battery includes a dispersant-containing layer with good solid electrolyte dispersibility.

### BRIEF DESCRIPTION OF DRAWINGS

FIG. 1 is a schematic cross-sectional view illustrating an example of the all solid state battery in the present disclosure.

FIG. 2 is a flowchart illustrating an example of the method for producing an all solid state battery in the present disclosure.

### DESCRIPTION OF EMBODIMENTS

The all solid state battery and the method for producing an all solid state battery in the present disclosure are hereinafter described in details.

A. All Solid State Battery

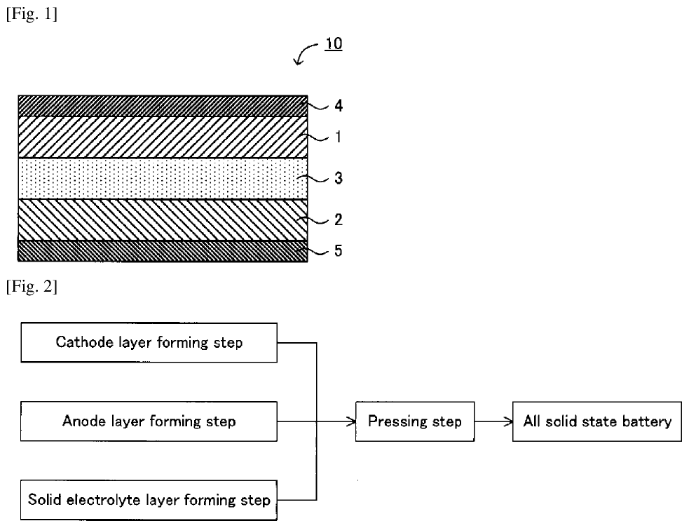

FIG. 1 is a schematic cross-sectional view illustrating an example of the all solid state battery in the present disclosure. All solid state battery 10 shown in FIG. 1 comprises cathode layer 1, anode layer 2, solid electrolyte layer 3 disposed between cathode layer 1 and anode layer 2, cathode current collector 4 for collecting currents of cathode layer 1, and anode current collector 5 for collecting currents of anode layer 2. At least one of cathode layer 1, anode layer 2, and solid electrolyte layer 3 is a dispersant-containing layer including at least a solid electrolyte and a dispersant.

According to the present disclosure, by using a specific dispersant in a predetermined proportion, an all solid state battery including a dispersant-containing layer with good solid electrolyte dispersibility may be obtained. For example, in a layer wherein the solid electrolyte is locally agglutinated, an ion conductive path is likely to be insufficient. Particularly, when the ion conductive path is insufficient in an electrode layer including active material, a part of the active material is isolated so that sufficient capacity may not be obtained in some cases. Therefore, it is preferable that the dispersibility of the solid electrolyte (evenness and stability in relation to dispersing) is improved.

In the present disclosure, a specific dispersant is used in a predetermined proportion. As the result, the dispersibility of the solid electrolyte is improved so that the ion conductivity in the dispersant-containing layer is improved. Also, by improving the dispersibility of the solid electrolyte in the dispersant-containing layer, cycle property is improved.

1. Dispersant-Containing Layer

The dispersant-containing layer includes at least a solid electrolyte and a dispersant.

(1) Dispersant

The dispersant has an amine value. The solid electrolyte usually has an affinity to an amine. Therefore, the dispersant having the amine value is adsorbed to the solid electrolyte, and as the result, the dispersibility of the solid electrolyte is improved. The amine value of the dispersant is usually 20 mgKOH/g or more, and may be 30 mgKOH/g or more. When the amine value of the dispersant is too low, the solid electrolyte dispersibility improving effect may not be obtained. Meanwhile, the amine value of the dispersant is usually 200 mgKOH/g or less, and may be 150 mgKOH/g or less. When the amine value of the dispersant is too high, solubility to organic solvents (dispersion media) may be lowered so that the solid electrolyte dispersibility improving effect may not be obtained. Also, when the amine value of the dispersant is too high, the production of the dispersant itself may be difficult. The amine value of the dispersant is specified by carrying out a measurement according to DIN (Deutsche Institut fur Normung) 16945. Specifically, 0.9 g to 1.3 g of a sample is added to a 200 ml beaker, and 50 ml of glacial acetic acid is added. Then, a titration is carried out with HClO₄/acetic acid solution of 0.1 N and an automatic potentiometric titrator (Titrator-DL 40 from Mettler Toledo, Ag/AgCl electrode). Then, the amine value is specified by the following formula.

Amine value (mgKOH/g)=(a−b)×5.61/E

The “a” in the formula is the amount (ml) of the HClO₄ of 0.1 N required for the titration, “b” is the amount (ml) of the HClO₄ of 0.1 N required for the titration of a blank, and “E” is the weight (g) of the sample.

The dispersant may or may not have an acid value, and the former is preferable. That is, the acid value of the dispersant may be more than 0, or may be 0, and the former is preferable. The solid electrolyte usually has an affinity to an acid. Therefore, the dispersant having the acid value is adsorbed to the solid electrolyte so that the dispersibility of the solid electrolyte is improved. Incidentally, the amine value is presumed to be more advantageous for the effect of improving the dispersibility, than the acid value. The acid value of the dispersant is, for example, 10 mgKOH/g or more, and may be 20 mgKOH/g or more. Meanwhile, the acid value of the dispersant is, for example, 150 mgKOH/g or less, may be 100 mgKOH/g or less, and may be 50 mgKOH/g or less. The acid value of the dispersant is specified by carrying out a measurement according to DIN EN ISO 2114. Specifically, 0.9 g to 1.3 g of a sample is added to an 80 ml beaker, and 50 ml of acetone is added. Then, a titration is carried out with NaOH aqueous solution of 0.1 N and an automatic potentiometric titrator (Titrator-DL 40 from Mettler Toledo, Ag/AgCl electrode). Then, the acid value is specified by the following formula.

Acid value (mgKOH/g)=(a−b)×5.61/E

The “a” in the formula is the amount (ml) of the NaOH of 0.1 N required for the titration, “b” is the amount (ml) of the NaOH of 0.1 N required for the titration of a blank, and “E” is the weight (g) of the sample.

The weight-average molecular weight of the dispersant is, for example, 200 g/mol or more, may be 300 g/mol or more, may be 1,000 g/mol or more, and may be 1,500 or more. When the weight-average molecular weight of the dispersant is too low, the solid electrolyte dispersibility improving effect may not be obtained. Meanwhile, the weight-average molecular weight of the dispersant is usually less than 1,500,000 g/mol, may be 150,000 g/mol or less, and may be 100,000 g/mol or less. When the weight-average molecular weight of the dispersant is too high, the number of molecules of the dispersant is relatively lowered so that the solid electrolyte dispersibility improving effect may not be obtained. The weight-average molecular weight (M_{w}) is specified as a polystyrene equivalent based on GPC method.

The dispersant includes an amino group in the molecule. The amino group may be —NH₂, may be —NHR (R is an element or a group other than hydrogen), and may be —NRR′ (R and R′ are respectively independently an element or a group other than hydrogen). Also, the dispersant may or may not include an amide bonding (—NH—CO—) in the molecule. Also, the dispersant may or may not include a hydroxyl group (—OH group) in the molecule. Further, the dispersant may or may not include a branched structure in the molecule.

The dispersant may be an aminoamide (amine amide). The aminoamide is a compound including an amino group and an amide bonding in the molecule. It is preferable that the N element in the amino group and the C element in the amide bonding are bonded via one or more C element(s). Examples of the aminoamide may include an unsaturated polyaminoamide and an alkylolaminoamide. The unsaturated polyamine amide may be, for example, a salt of unsaturated polyamine amides and lower molecular weight acidic polyesters. Also, the unsaturated polyamine amide may be, for example, a reaction product of tall-oil fatty acids with polyethylene glycol, maleic anhydride, and unsaturated polyamine amide salt (e.g. a reaction product of tall-oil fatty acids and diethylene triamine). The alkylolaminoamide may be, for example, a condensation products of tall-oil fatty acids with 2-[(2-aminoethyl)amino]ethanol. Meanwhile, the dispersant may be a polyamine copolymer. Examples of the polyamine copolymer may include a polyester-polyamine copolymer.

The proportion of the dispersant in the dispersant-containing layer is usually 0.1 weight % or more, and may be 0.5 weight % or more. When the proportion of the dispersant is too low, the solid electrolyte dispersibility improving effect may not be obtained. Meanwhile, the proportion of the dispersant in the dispersant-containing layer is usually 20 weight % or less, may be 15 weight % or less, may be 10 weight % or less, and may be 5 weight % or less. When the proportion of the dispersant is too high, the proportion of the solid electrolyte is relatively lowered so that the ion conductivity in the dispersant-containing layer may be lowered. The dispersant-containing layer may include only one kind of the dispersant, and may include two kinds or more of the dispersant.

(2) Solid Electrolyte

The solid electrolyte improves ion conductivity in the dispersant-containing layer. Examples of the solid electrolyte may include an inorganic solid electrolyte such as a sulfide solid electrolyte, an oxide solid electrolyte, a nitride solid electrolyte, and a halide solid electrolyte. Among them, the sulfide solid electrolyte is preferable for high ion conductivity, furthermore, for high dispersibility and high affinity.

Examples of the sulfide solid electrolyte includes a solid electrolyte including a Li element, an X element (X is at least one kind of P, As, Sb, Si, Ge, Sn, B, Al, Ga, and In), and a S element. Also, the sulfide solid electrolyte may further include at least either one of an O element and a halogen element. Examples of the halogen element may include a F element, a Cl element, a Br element, and an I element.

The sulfide solid electrolyte preferably has an anion structure of an ortho composition (PS₄³⁻ structure, SiS₄⁴⁻ structure, GeS₄⁴⁻ structure, AlS₃³⁻ structure, and BS₃³⁻ structure) as the main component of the anion. The reason therefor is to allow a sulfide solid electrolyte to have high chemical stability. The proportion of the anion structure of an ortho composition with respect to all the anion structures in the sulfide solid electrolyte is, for example, 70 mol % or more and may be 90 mol % or more. The proportion of the anion structure of an ortho composition may be determined by methods such as a Raman spectroscopy, NMR, and XPS. Specific examples of the sulfide solid electrolyte may include xLi₂S-(1−x)P₂S₅ (x is 0.7 or more and 0.8 or less), and yLiI-zLiBr-(100−y−z)Li₃PS₄ (y is 0 or more and 30 or less, and z is 0 or more and 30 or less).

The sulfide solid electrolyte may be a glass based sulfide solid electrolyte, and may be a glass ceramic based sulfide solid electrolyte. The glass based sulfide solid electrolyte may be obtained by vitrifying raw material. The glass ceramic based sulfide solid electrolyte may be obtained by, for example, heat treating the above described glass based sulfide solid electrolyte. Also, the sulfide solid electrolyte preferably includes a predetermined crystal structure. Examples of the crystal structure may include a Thio-LISICON type crystal structure, a LGPS type crystal structure, and an argyrodite type crystal structure.

Examples of the oxide solid electrolyte may include a garnet type solid electrolyte such as Li₇La₃Zr₂O₁₂, a perovskite type solid electrolyte such as (Li, La)TiO₃, and a nasicon type solid electrolyte such as Li(Al, Ti)(PO₄)₃. Examples of the nitride solid electrolyte may include Li₃N, and examples of the halide solid electrolyte may include LiCl, LiI, and LiBr.

Examples of the shape of the solid electrolyte may include a granular shape. The average particle size (D₅₀) of the solid electrolyte is, for example, 0.05 μm or more, and may be 0.1 μm or more. Meanwhile, the average particle size (D₅₀) of the solid electrolyte is, for example, 50 μm or less, and may be 20 μm or less. The average particle size of the solid electrolyte may be calculated from measurement with a laser diffraction type particle size distribution meter or a scanning electron microscope (SEM).

(3) Dispersant-Containing Layer

In the present disclosure, at least one of the cathode layer, the anode layer, and the solid electrolyte layer is the dispersant-containing layer. Further, two layers of the cathode layer, the anode layer, and the solid electrolyte layer may be the dispersant-containing layer, and all of the cathode layer, the anode layer, and the solid electrolyte layer may be the dispersant-containing layer.

2. Cathode Layer

The cathode layer is a layer including at least a cathode active material, and may further include at least one of a solid electrolyte, a conductive material, a binder, and a dispersant. Also, the cathode layer may be the above described dispersant-containing layer. In that case, the cathode layer includes at least a cathode active material, a solid electrolyte and a dispersant.

Examples of the cathode active material may include an oxide active material. Examples of the oxide active material may include rock salt bed type active materials such as LiCoO₂, LiMnO₂, LiNiO₂, LiVO₂, and LiNi_{1/3}Co_{1/3}Mn_{1/3}O₂; spinel type active materials such as LiMn₂O₄, Li₄Ti₅O₁₂, and Li(Ni_{0.5}Mn_{1.5})O₄; and olivine type active materials such as LiFePO₄, LiMnPO₄, LiNiPO₄, and LiCoPO₄.

A coating layer including a Li ion conductive oxide may be formed on the surface of the oxide active material. By providing the coating layer, a reaction between the oxide active material and the solid electrolyte (particularly, sulfide solid electrolyte) may be suppressed. Examples of the Li ion conductive oxide may include LiNbO₃. The thickness of the coating layer is, for example, 1 nm or more and 30 nm or less.

Examples of the shape of the cathode active material may include a granular shape. The average particle size (D₅₀) of the cathode active material is, for example, 10 nm or more, and may be 100 nm or more. Meanwhile, the average particle size (D₅₀) of the cathode active material is, for example, 50 μm or less, and may be 20 μm or less. The average particle size (D₅₀) may be calculated from an observation with, for example, a scanning electron microscope (SEM).

The solid electrolyte and the dispersant may be in the same contents as those described in “1. Dispersant-containing layer” above; thus, the description herein is omitted. The proportion of the solid electrolyte in the cathode layer is, for example, 5 weight % or more, may be 10 weight % or more, and may be 15 weight % or more. When the proportion of the solid electrolyte is too low, good ion conductive path may not be formed in the cathode layer. Meanwhile, the proportion of the solid electrolyte in the cathode layer is, for example, 40 weight % or less, may be 30 weight % or less, and may be 25 weight % or less. When the proportion of the solid electrolyte is too high, the proportion of the cathode active material becomes relatively low so that the energy density of an all solid state battery may be low.

Examples of the conductive material may include a carbon material, a metal particle, and a conductive polymer. Examples of the carbon material may include a granular carbon materials such as acetylene black (AB) and Ketjen black (KB); and a fibrous carbon materials such as carbon fiber, carbon nanotube (CNT), and carbon nanofiber (CNF). Also, examples of the binder may include a fluorine-based binder, and a rubber-based binder. The thickness of the cathode layer is, for example, 0.1 μm or more and 1000 μm or less.

3. Anode Layer

The anode layer is a layer including at least an anode active material, and may further include at least one of a solid electrolyte, a conductive material, a binder, and a dispersant. Also, the anode layer may be the above described dispersant-containing layer. In that case, the anode layer includes at least an anode active material, a solid electrolyte and a dispersant.

Examples of the anode active material may include a metal active material, a carbon active material, and an oxide active material. Examples of the metal active material may include a metal simple substance and a metal alloy. Examples of the metal element included in the metal active material may include Si, Sn, In, and Al. The metal alloy is preferably a metal alloy including the above described metal element as the main component. Examples of the carbon active material may include mesocarbon microbead (MCMB), highly oriented pyrolytic graphite (HOPG), hard carbon, and soft carbon. Examples of the oxide active material may include a lithium titanate such as Li₄Ti₅O₁₂.

The solid electrolyte and the dispersant may be in the same contents as those described in “1. Dispersant-containing layer” above; thus, the description herein is omitted. The proportion of the solid electrolyte in the anode layer is, for example, 5 weight % or more, may be 10 weight % or more, and may be 15 weight % or more. When the proportion of the solid electrolyte is too low, good ion conductive path may not be formed in the anode layer. Meanwhile, the proportion of the solid electrolyte in the anode layer is, for example, 40 weight % or less, may be 30 weight % or less, and may be 25 weight % or less. When the proportion of the solid electrolyte is too high, the proportion of the anode active material becomes relatively low so that the energy density of an all solid state battery may be low.

The conductive material and the binder may be in the same contents as those described in “2. Cathode layer” above; thus, the description herein is omitted. The thickness of the anode layer is, for example, 0.1 μm or more and 1000 μm or less.

4. Solid Electrolyte Layer

The solid electrolyte layer is a layer disposed between the cathode layer and the anode layer, and including at least a solid electrolyte. The solid electrolyte layer may further include at least one of a binder, and a dispersant. Also, the solid electrolyte layer may be the above described dispersant-containing layer.

The solid electrolyte, the dispersant, and the binder used for the solid electrolyte layer may be in the same contents as those described in “1. Dispersant-containing layer” and “2. Cathode layer” above; thus, the description herein is omitted. Also, the proportion of the solid electrolyte in the solid electrolyte layer is not particularly limited, and is, for example, 60 weight % or more, may be 80 weight % or more, and may be 95 weight % or more. Meanwhile, the proportion of the solid electrolyte in the solid electrolyte layer may be 100 weight %, and may be less than 100 weight %. The thickness of the solid electrolyte layer is, for example, 0.1 μm or more and 1000 μm or less.

5. All Solid State Battery

The all solid state battery in the present disclosure preferably comprises a cathode current collector for collecting currents of the cathode layer and an anode current collector for collecting currents of the anode layer. Examples of the materials for the cathode current collector may include SUS, aluminum, nickel, iron, titanium, and carbon. Meanwhile, examples of the materials for the anode current collector may include SUS, copper, nickel, and carbon.

The all solid state battery in the present disclosure may further include a confining jig that applies a confining pressure along the thickness direction, to the cathode layer, the solid electrolyte layer and the anode layer. The confining pressure is, for example, 0.1 MPa or more, may be 1 MPa or more, and may be 5 MPa or more. By applying the confining pressure, the ion conductivity and the electron conductivity in an all solid state battery are improved. Meanwhile, the confining pressure is, for example, 100 MPa or less, may be 50 MPa or less, and may be 20 MPa or less. When the confining pressure is too high, the confining jig may be increased in size.

The kind of the all solid state battery in the present disclosure is not particularly limited, and is typically a lithium ion battery. Also, the all solid state battery in the present disclosure may be a primary battery, and may be a secondary battery. Among the above, the secondary battery is preferable, so as to be repeatedly charged and discharged, and is useful as, for example, a car-mounted battery. Also, the all solid state battery in the present disclosure may be a single cell battery and may be a stacked battery. The stacked battery may be a monopolar type stacked battery (a stacked battery connected in parallel), and may be a bipolar type stacked battery (a stacked battery connected in series). Examples of the shape of the all solid state battery may include a coin shape, a laminate shape, a cylindrical shape, and a square shape.

B. Method for Producing all Solid State Battery

FIG. 2 is a flowchart illustrating an example of the method for producing an all solid state battery in the present disclosure. As shown in FIG. 2, the method for producing an all solid state battery preferably comprise a cathode layer forming step of forming a cathode layer, an anode layer forming step of forming an anode layer, a solid electrolyte layer forming step of forming a solid electrolyte layer, and a pressing step of placing the cathode layer, the solid electrolyte layer, and the anode layer in this order, and pressing. Particularly, in the present disclosure, at least one of the cathode layer, the anode layer, and the solid electrolyte layer is a dispersant-containing layer, and the dispersant-containing layer is formed by using a slurry including at least the solid electrolyte and the dispersant.

According to the present disclosure, by using a slurry including a specific dispersant, an all solid state battery including a dispersant-containing layer with good solid electrolyte dispersibility may be obtained.

Example for a method for forming the dispersant-containing layer may include a method including a coating treatment for forming a coating layer by coating a substrate with a slurry including at least the solid electrolyte and the dispersant, and drying treatment for forming a dispersant-containing layer by drying the coating layer.

The slurry used for the coating treatment includes at least the solid electrolyte and the dispersant. When the dispersant-containing layer is a cathode layer, the slurry further includes a cathode active material. Similarly, when the dispersant-containing layer is an anode layer, the slurry further includes an anode active material. Also, the slurry may further include at least one of a conductive material and a binder, as necessary.

A dispersion medium used for the slurry is not particularly limited, and examples may include ketone compounds such as methyl ethyl ketone, diethyl ketone, methyl propyl ketone, methyl isobutyl ketone, dibutyl ketone, and di-isobutyl ketone; ether compounds such as diethylene glycol diethyl ether, cyclopentyl methyl ether, dibutyl ether, dipentyl ether, and anisole; ester compounds such as ethyl butyrate, butyl butyrate, and butyl 2-methylbutyrate. The ketone compounds, the ether compounds and the ester compounds may or may not include a cyclic structure, and the latter is preferable for the lower reactivity with the solid electrolyte (particularly, sulfide solid electrolyte).

The method for preparing the slurry is not particularly limited. For the high solid electrolyte dispersibility, it is preferable, for example, to prepare a first solution by dissolving a dispersant into a dispersion medium, then, add and disperse a solid electrolyte to the first solution. Also, when preparing a slurry including other materials such as an active material, a conductive material, and a binder, in addition to the solid electrolyte and the dispersant, it is preferable to prepare a first dispersion fluid by adding the solid electrolyte to the first solution, and then, adding the other materials. That is, it is preferable to add just the solid electrolyte to the first solution for the high solid electrolyte dispersibility.

Examples of the method for dispersion may include a method using a common device such as a dissolver, a homomixer, a kneader, a roll mill, a sand mill, an attritor, a ball mill, a vibrator mill, a high speed impeller mill, an ultrasonic homogenizer, and a shaker.

Examples of the substrate used for the coating treatment may include a current collector, and a transfer sheet. Examples of the transfer sheet may include a resin sheet such as a fluorine based resin sheet, and a metal sheet. Examples of the method for coating the slurry may include common methods such as a doctor blade method, a die coating method, a gravure coating method, a spray coating method, an electrostatic coating method and a bar coating method.

The drying temperature in the drying treatment is, for example, 60 deg. C. or more, may be 80 deg. C. or more, and may be 100 deg. C. or more. Meanwhile, the drying temperature is, for example, 220 deg. C. or less, may be 200 deg. C. or less, may be 170 deg. C. or less, and may be 160 deg. C. or less. Examples of the method for drying the coating layer may include common methods such as warm-air drying, infrared ray drying, reduced-pressure drying, and dielectric heat drying. Examples of the drying atmosphere may include inert gas atmospheres such as an Ar gas atmosphere and a nitrogen gas atmosphere. Also, the drying may be carried out under an atmospheric pressure, and may be under a reduced pressure.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

### Example 1

<Production of Cathode Structure>

The followings were weighed; 64.4 weight parts of a cathode active material (LiNi_{1/3} Mn_{1/3}Co_{1/3}O₂ coated with LiNbO₃), 27.6 weight parts of a sulfide solid electrolyte (LiI—Li₂O—Li₂S—P₂S₅), 3 weight parts of a conductive material (vapor-grown carbon fiber), a PVDF binder solution so as the solid content to be 4 weight parts, and 1 weight part of a dispersant (unsaturated polyaminoamide, Al). Incidentally, the weight ratio of the cathode active material and the sulfide solid electrolyte was cathode active material:sulfide solid electrolyte=70:30.

Next, methyl isobutyl ketone was prepared, and the weighed dispersant was added and dissolved. After dissolution of the dispersant was confirmed, the weighed sulfide solid electrolyte was added and dispersed by using an ultrasonic homogenizer (UH-50, manufactured by SMT Co., Ltd.) for one minute. Then, other weighed materials (cathode active material, binder and conductive material) were added, further, methyl isobutyl ketone was added so as the solid content to be 60 weight %. A slurry was obtained by dispersing the obtained mixture by using the ultrasonic homogenizer for one minute.

After that, a surface of a cathode current collector (aluminum foil) was coated with the slurry by using an applicator, naturally dried for 5 minutes, warm-air dried at 100 deg. C. for 60 minutes. Thereby, a cathode structure including the cathode current collector and the cathode layer was obtained.

<Production of Anode Structure>

The followings were weighed; 67.2 weight parts of an anode active material (natural graphite, D₅₀=15 μm), 28.8 weight parts of a sulfide solid electrolyte (LiI—Li₂O—Li₂S—P₂S₅), and a PVDF binder solution so as the solid content to be 4 weight parts. Incidentally, the weight ratio of the anode active material and the sulfide solid electrolyte was anode active material:sulfide solid electrolyte=70:30.

Next, methyl isobutyl ketone was prepared, and the weighed sulfide solid electrolyte was added and dispersed by using an ultrasonic homogenizer (UH-50, manufactured by SMT Co., Ltd.) for one minute. Then, other weighed materials (anode active material and binder) were added, further, methyl isobutyl ketone was added so as the solid content to be 55 weight %. A slurry was obtained by dispersing the obtained mixture by using the ultrasonic homogenizer for one minute.

After that, a surface of an anode current collector (SUS foil) was coated with the slurry by using an applicator, naturally dried for 5 minutes, warm-air dried at 100 deg. C. for 60 minutes. Thereby, an anode structure including the anode current collector and the anode layer was obtained.

<Production of Solid Electrolyte Layer>

The followings were weighed; 96 weight parts of a sulfide solid electrolyte (LiI—Li₂O—Li₂S—P₂S₅), and a PVDF binder solution so as the solid content to be 4 weight parts. These were mixed, and methyl isobutyl ketone was added so as the solid content to be 45 weight %. A slurry was obtained by dispersing the obtained mixture by using the ultrasonic homogenizer for one minute.

After that, a surface of a substrate (aluminum foil) was coated with the slurry by using an applicator, naturally dried for 5 minutes, warm-air dried at 100 deg. C. for 30 minutes. Thereby, a solid electrolyte layer was obtained on the substrate.

<Production of all Solid State Battery>

The substrate was peeled off from the solid electrolyte layer in an inert gas atmosphere, the cathode structure was placed on one surface of the solid electrolyte layer, and the anode structure was placed on other side surface of the solid electrolyte layer. An all solid state battery was obtained by pressing the obtained stack under 4.3 ton.

### Examples 2 to 11

An all solid state battery was obtained in the same manner as in Example 1 except that the kind and the proportion of the dispersant in the cathode layer were varied as shown in Table 1 and Table 2. Incidentally, in Tables 1 to 4, CA indicates a cathode layer, SE indicates a solid electrolyte layer, and AN indicates an anode layer. Also, for the kinds of the dispersant, Group A indicates an unsaturated polyaminoamide Group B indicates an alkylolaminoamide, and Group C indicates a polyester-polyamine copolymer.

### Example 12

<Production of Cathode Structure>

A cathode structure was obtained in the same manner as in Example 1 except that the dispersant was not used, and the followings were used; 65.1 weight parts of a cathode active material (LiNi_{1/3}Mn_{1/3}Co_{1/3}O₂ coated with LiNbO₃), 27.9 weight parts of a sulfide solid electrolyte (LiI—Li₂O—Li₂S—P₂S), 3 weight parts of a conductive material (vapor-grown carbon fiber), and a PVDF binder solution so as the solid content to be 4 weight parts.

<Production of Anode Structure>

The followings were weighed; 66.5 weight parts of an anode active material (natural graphite, D₅₀=15 μm), 28.5 weight parts of a sulfide solid electrolyte (LiI—Li₂O—Li₂S—P₂S₅) a PVDF binder solution so as the solid content to be 4 weight parts, and 1 weight part of a dispersant (unsaturated polyaminoamide, Al). Incidentally, the weight ratio of the anode active material and the sulfide solid electrolyte was anode active material:sulfide solid electrolyte=70:30.

Next, methyl isobutyl ketone was prepared, and the weighed dispersant was added and dissolved. After dissolution of the dispersant was confirmed, the weighed sulfide solid electrolyte was added and dispersed by using an ultrasonic homogenizer (UH-50, manufactured by SMT Co., Ltd.) for one minute. Then, other weighed materials (anode active material and binder) were added, further, methyl isobutyl ketone was added so as the solid content to be 55 weight %. A slurry was obtained by dispersing the obtained mixture by using the ultrasonic homogenizer for one minute. An anode structure was obtained in the same manner as in Example 1 except that the obtained slurry was used.

<Production of Solid Electrolyte Layer>

A solid electrolyte layer was obtained in the same manner as in Example 1.

<Production of all Solid State Battery>

An all solid state battery was obtained in the same manner as in Example 1 except that the obtained cathode structure, anode structure, and solid electrolyte layer were used.

### Example 13

At first, a cathode structure (a cathode structure not including a dispersant) was obtained in the same manner as in Example 12. Then, an anode structure (an anode structure not including a dispersant) was obtained in the same manner as in Example 1. Then, the followings were weighed; 93 weight parts of a sulfide solid electrolyte (LiI—Li₂O—Li₂S—P₂S₅), a PVDF binder solution so as the solid content to be 4 weight parts, and 3 weight parts of a dispersant (unsaturated polyaminoamide, A1). These were mixed, and methyl isobutyl ketone was added so as the solid content to be 45 weight %. A slurry was obtained by dispersing the obtained mixture by using the ultrasonic homogenizer for one minute. A solid electrolyte layer was obtained in the same manner as in Example 1 except that the obtained slurry was used. An all solid state battery was obtained in the same manner as in Example 1 except that the obtained cathode structure, anode structure, and solid electrolyte layer were used.

### Example 14

At first, a cathode structure (a cathode structure including a dispersant) was obtained in the same manner as in Example 1. Then, an anode structure (an anode structure including a dispersant) was obtained in the same manner as in Example 12. Then, a solid electrolyte layer (a solid electrolyte layer including a dispersant) was obtained in the same manner as in Example 13. An all solid state battery was obtained in the same manner as in Example 1 except that the obtained cathode structure, anode structure, and solid electrolyte layer were used.

### Comparative Example 1

An all solid state battery was obtained in the same manner as in Example 1 except that the dispersant was not used in the cathode layer, and the composition of the slurry used for the cathode layer was varied as shown in Table 4.

### Comparative Examples 2 to 6

An all solid state battery was obtained in the same manner as in Example 1 except that the kind and the proportion of the dispersant in the cathode layer were varied as shown in Table 4.

<<Evaluation>>

<Dispersibility>

The dispersibility of the solid electrolyte was evaluated by using the slurry including the dispersant produced in Examples 1 to 14 and Comparative Examples 1 to 6. The evaluation of the dispersibility was carried out by using a grind gage (0 μm to 100 μm scale) based on JIS 5600-2-5: 1999 (ISO1524: 1983).
A: less than 10 μm . . . better
B: 10 μm or more and less than 30 μm . . . good
C: 30 μm or more and less than 70 μm . . . bad
D: 70 μm or more . . . worse

<Resistivity>

The Li ion resistivity of the all solid state batteries obtained in Examples 1 to 14 and Comparative Examples 1 to 6 was determined by an AC impedance method. Solartron 1260 was used for measuring, and the measuring conditions were; applied voltage of 10 mV, measuring frequency range of 0.01 MHz to 1 MHz at ambient temperature. Also, upon measuring, the all solid state batteries were adjusted as described below. At first, in an environment of 25 deg. C.±1 deg. C., the not yet charged all solid state batteries were charged at constant current of current value of 0.1 C until the voltage of a terminal reaches the predetermined voltage, and then, the all solid state batteries were charged at constant current/constant voltage for one hour, maintaining the voltage at the predetermined voltage. Next, the all solid state batteries were discharged at constant current/constant voltage for 10 hour to 4.2 V at current value of 0.2 C. After that, in an environment of 25 deg. C.±1 deg. C., the all solid state batteries were charged at constant current to 4.0 V at current value of 0.2 C.
A: less than 0.9 Ωm . . . better
B: 0.9 Ωm or more and less than 2.4 Ωm . . . good
C: 2.4 Ωm or more and less than 5.5 Ωm . . . bad
D: 5.5 Ωm or more . . . worse

<Cycle Property>

The all solid state batteries obtained in Examples 1 to 14 and Comparative Examples 1 to 6 were repeatedly charged and discharge at constant current (CC charge and discharge) in a range of 4.2 V to 2.5 V. The charge and discharge were carried out in an environment of 25 deg. C.±1 deg. C., at current value of 1.0 C. The capacity durability was calculated by dividing the discharge capacity of the 200^{th} cycle by the discharge capacity of the first cycle. The evaluation standards for the capacity durability (cycle property) are shown below.
A: 90% or more . . . better
B: 85% or more and less than 90% . . . good
C: 80% or more and less than 85% . . . bad
D: less than 80% . . . worse

TABLE 1

| Example | | 1 | 2 | 3 | 4 | 5 | 6 |
|---|---|---|---|---|---|---|---|
| Layer | | CA | CA | CA | CA | CA | CA |
| Dispersant | Kind | A1 | A1 | A1 | A1 | A2 | A3 |
| | Amine value | 35 | 35 | 35 | 35 | 35 | 35 |
| | (mgKOH/g) | | | | | | |
| | Acid value | 50 | 50 | 50 | 50 | 50 | 50 |
| | (mgKOH/g) | | | | | | |
| | Mw (g/mol) | 5,000 | 5,000 | 5,000 | 5.000 | 100,000 | 1,000 |
| | Proportion (wt %) | 1 | 20 | 15 | 0.1 | 1 | 1 |
| Active material | Proportion (wt %) | 64.4 | 51.1 | 54.6 | 65.0 | 64.4 | 64.4 |
| Solid electrolyte | Proportion (wt %) | 27.6 | 21.9 | 23.4 | 27.9 | 27.6 | 27.6 |
| Conductive materia [symbol] | Proportion (wt %) | 3 | 3 | 3 | 3 | 3 | 3 |
| Binder | Proportion (wt %) | 4 | 4 | 4 | 4 | 4 | 4 |

| | | | | | | |
|---|---|---|---|---|---|---|
| Dispersibility | A | A | A | B | B | B |
| Resistivity | A | D | B | A | A | A |
| Cycle property | A | C | A | A | A | A |

[symbol]

indicates data missing or illegible when filed

TABLE 2

| Example | | 7 | 8 | 9 | 10 | 11 |
|---|---|---|---|---|---|---|
| Layer | | CA | CA | CA | CA | CA |
| Dispersant | Kind | B1 | B2 | B3 | B4 | C1 |
| | Amine value | 200 | 140 | 20 | 140 | 80 |
| | (mgKOH/g) | | | | | |
| | Acid value | 0 | 0 | 0 | 0 | 35 |
| | (mgKOH/g) | | | | | |
| | Mw (g/mol) | 10,000 | 8,000 | 8,000 | 150,000 | 9,000 |
| | Proportion (wt %) | 1 | 1 | 1 | 1 | 1 |
| Active material | Proportion (wt %) | 64.4 | 64.4 | 64.4 | 64.4 | 64.4 |
| Solid electrolyte | Proportion (wt %) | 27.6 | 27.6 | 27.6 | 27.6 | 27.6 |
| Conductive materia [symbol] | Proportion (wt %) | 3 | 3 | 3 | 3 | 3 |
| Binder | Proportion (wt %) | 4 | 4 | 4 | 4 | 4 |

| | | | | | |
|---|---|---|---|---|---|
| Dispersibility | A | A | A | B | A |
| Resistivity | A | A | A | A | A |
| Cycle property | A | A | A | B | A |

[symbol]

indicates data missing or illegible when filed

TABLE 3

| Example | | 12 | 13 | 14 | | |
|---|---|---|---|---|---|---|
| Layer | | AN | SE | CA | SE | AN |
| Dispersant | Kind | A1 | A1 | A1 | A1 | A1 |
| | Amine value | 35 | 35 | 35 | 35 | 35 |
| | (mgKOH/g) | | | | | |
| | Acid value | 50 | 50 | 50 | 50 | 50 |
| | (mgKOH/g) | | | | | |
| | Mw (g/mol) | 5,000 | 5,000 | 5,000 | 5,000 | 5,000 |
| | Proportion (wt %) | 1 | 3 | 1 | 3 | 1 |
| Active material | Proportion (wt %) | 66.5 | 0 | 64.4 | 0 | 66.5 |
| Solid electrolyte | Proportion (wt %) | 28.5 | 93 | 27.6 | 93 | 28.5 |
| Conductive materia [symbol] | Proportion (wt %) | 0 | 0 | 3 | 0 | 0 |
| Binder | Proportion (wt %) | 4 | 4 | 4 | 4 | 4 |

| | | | | | |
|---|---|---|---|---|---|
| Dispersibility | A | A | A | A | A |

| | | | |
|---|---|---|---|
| Resistivity | A | A | A |
| Cycle property | A | A | A |

[symbol]

indicates data missing or illegible when filed

TABLE 4

| Comparative Example | | 1 | 2 | 3 | 4 | 5 | 6 |
|---|---|---|---|---|---|---|---|
| Layer | | CA | CA | CA | CA | CA | CA |
| Dispersant | Kind | — | A1 | A5 | A6 | A7 | A8 |
| | Amine value | — | 35 | 250 | 5 | <0.3 | 35 |
| | (mgKOH/g) | | | | | | |
| | Acid value | — | 50 | 50 | 50 | 50 | 50 |
| | (mgKOH/g) | | | | | | |
| | Mw (g/mol) | — | 5,000 | 5,000 | 5,000 | 5,000 | 1,500,000 |
| | Proportion (wt %) | 0 | 0.05 | 1 | 1 | 1 | 1 |
| Active material | Proportion (wt %) | 65.1 | 65.07 | 64.4 | 64.4 | 64.4 | 64.4 |
| Solid electrolyte | Proportion (wt %) | 27.9 | 27.89 | 27.6 | 27.6 | 27.6 | 27.6 |
| Conductive materia [symbol] | Proportion (wt %) | 3 | 3 | 3 | 3 | 3 | 3 |
| Binder | Proportion (wt %) | 4 | 4 | 4 | 4 | 4 | 4 |

| | | | | | | |
|---|---|---|---|---|---|---|
| Dispersibility | D | D | D | D | D | D |
| Resistivity | B | B | C | C | C | D |
| Cycle property | C | C | C | C | C | D |

[symbol]

indicates data missing or illegible when filed

As shown in Table 1 to Table 3, it was confirmed that good dispersibility was obtained in each of Examples 1 to 14. Incidentally, the resistivity and the cycle property were not good in Example 2, although good dispersibility was obtained. Meanwhile, in Example 3, all the dispersibility, the resistivity, and the cycle property were good. From the above, it was suggested that the proportion of the dispersant was preferably 15 weight % or less.

Meanwhile, as shown in Table 4, it was confirmed that good dispersibility was not obtained in each of Comparative Examples 1 to 6. The reason therefor is presumed that the dispersant was not used in Comparative Example 1. In Comparative Example 2, the reason therefor is presumed that the proportion of the dispersant was too low. In Comparative Example 3, the reason therefor is presumed that the amine value of the dispersant was too high. In Comparative Examples 4 and 5, the reason therefor is presumed that the amine value of the dispersant was too low. In Comparative Example 6, the reason therefor is presumed that the weight-average molecular weight of the dispersant was too high. Also, in Comparative Examples 1 to 6, the resistivity and the cycle property were also not good.

As described above, it was confirmed that, by using a specific dispersant in a predetermined proportion, a dispersant-containing layer with good solid electrolyte dispersibility may be obtained.

### REFERENCE SIGNS LIST

1 . . . cathode layer
2 . . . anode layer
3 . . . solid electrolyte layer
4 . . . cathode current collector
5 . . . anode current collector
10 . . . all solid state battery

1. An all solid state battery comprising a cathode layer, an anode layer, and a solid electrolyte layer disposed between the cathode layer and the anode layer, and
at least one of the cathode layer, the anode layer, and the solid electrolyte layer is a dispersant-containing layer including at least a solid electrolyte and a dispersant,
wherein the dispersant-containing laver includes an an aminoamide or a polyesterpolyamine copolymer as the dispersant,
an amine value of the dispersant is 20 mgKOH/g or more and 200 mgKOH/g or less,
a weight-average molecular weight of the dispersant is less than 1,500,000 g/mol, and
a proportion of the dispersant in the dispersant-containing layer is 0.1 weight % or more and 20 weight % or less.

2. The all solid state battery according to claim 1, wherein the weight-average molecular weight of the dispersant is 300 g/mol or more and 150,000 g/mol or less.

3. The all solid state battery according to claim 1, wherein an acid value of the dispersant is 0 mgKOH/g or more and 50 mgKOH/g or less.

4. (canceled)

5. The all solid state battery according to claim 1, wherein the aminoamide includes at least one of an unsaturated polyaminoamide and alkylolaminoamide.

6. (canceled)

7. The all solid state battery according to claim 1, wherein the cathode layer is the dispersant-containing layer, and
a proportion of the solid electrolyte in the cathode layer is 10 weight % or more and 30 weight % or less.

8. The all solid state battery according to claim 1, wherein the anode layer is the dispersant-containing layer, and
a proportion of the solid electrolyte in the anode layer is 10 weight % or more and 30 weight % or less.

9. The all solid state battery according to claim 1, wherein the solid electrolyte layer is the dispersant-containing layer, and
a proportion of the solid electrolyte in the solid electrolyte layer is 60 weight % or more.

10. A method for producing the all solid state battery according to claim 1, and
the dispersant-containing layer is formed by using a slurry including at least the solid electrolyte and the dispersant.
